(19) United States
(12) Patent Application Publication
(10) Pub. No.: US 2002/0166512 A1
(43) Pub. Date: Nov. 14, 2002

(54) Utility nozzle with comb apparatus for grooming pets

(76) Inventor: Austin Kit Corbett, Evansville, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/139,460

(22) Filed: May 6, 2002

Related U.S. Application Data
(60) Provisional application No. 60/290,227, filed on May 11, 2001.

(51) Int. Cl. A01K 13/00

(52) U.S. Cl. 119/611

(57) ABSTRACT

The present invention relates to a pet grooming apparatus and more particularly, an attachment to a prior art vacuum for grooming pet hair, and for removal of the loose hair as the pet is being groomed. The preferred embodiment of the present invention includes a utility nozzle having a wand connector for connecting the nozzle to a prior art vacuum, and a hair comb member, having a plurality of cone-shaped teeth preferably mounted in a single plane, and of study material in order to pass through the hair of a pet. Said hair comb member slidably positioned within the utility nozzle while the apparatus is pulled through the pet's hair, the hair comb member is cabled of collecting hair that is loosened from the pet when the plurality of cone-shaped teeth engage the pet, such collection of loosened hair and debris passing from the plurality of cone-shaped teeth through an air passage of the utility nozzle into the vacuum.

### CROSS REFERENCES TO RELATED APPLICATIONS

U.S. Provisional Application for Patent 60/290,227, filed May 11, 2001, with title “Utility Nozzle With Comb Insert For Grooming Pets”, which is hereby incorporated by reference. Applicant claims priority pursuant to 35 U.S.C. par. 119(e)(i).

### STATEMENT AS TO RIGHTS TO INVENTIONS MADE UNDER FEDERALLY Sponsored Research And DEVELOPMENT

Not Applicable

### BACKGROUND OF THE INVENTION

1. Field of the Invention

This invention relates to a pet grooming apparatus and more particularly, an attachment to a prior art vacuum for grooming pet hair, and for removal of the loose hair as the pet is being groomed.

2. Background Information

The use of vacuums for grooming pet hair is known in the prior art. Such prior art includes various attachments and vacuum mechanisms relating to pet hair grooming. U.S. Pat. No. 5,655,481 to Trahan discloses a hand-held pet grooming apparatus which includes a vacuum and bristle portion. The mechanism of Trahan incorporates its own vacuum and vacuum chamber for collecting pet hair when the vacuum is activated. This is a relatively costly, and uneconomical means of achieving the particular objective of collecting pet hair while grooming.

As will be seen from the subsequent description, the preferred embodiments of the present invention overcome these and other shortcomings of prior art.

### SUMMARY OF THE INVENTION

The present invention relates to a pet grooming apparatus , and more particularly, an attachment to a prior art vacuum for grooming pet hair, and for removal of the loose hair as the pet is being groomed. The preferred embodiment includes a utility nozzle which attaches to the prior art vacuum, and a hair comb member. Said utility nozzle having a top side, an under side, a wand connector for attaching the utility nozzle to the prior art vacuum, at least one tab, a passage, an air center wall, and a first and second lips. Said hair comb member further comprising a plurality of comb-shaped teeth, and a first and second ends.

The present invention provides a new and improved pet grooming apparatus which may be easily and efficiently manufactured and marketed. The present invention is susceptible of a low cost of manufacture with regard to both materials and labor, and which accordingly is then susceptible of low prices of sale to the consuming public, thereby making the present invention economically available to the buying public.

### BRIEF DESCRIPTION OF THE DRAWINGS

FIG. 1 illustrates a top view of the present invention, a utility nozzle with comb member for grooming pets.

FIG. 2 illustrates the underside view of the utility nozzle of FIG. 1, with the hair comb member attached therein.

FIG. 3 illustrates a top view of the utility nozzle and a perspective view of the hair comb member.

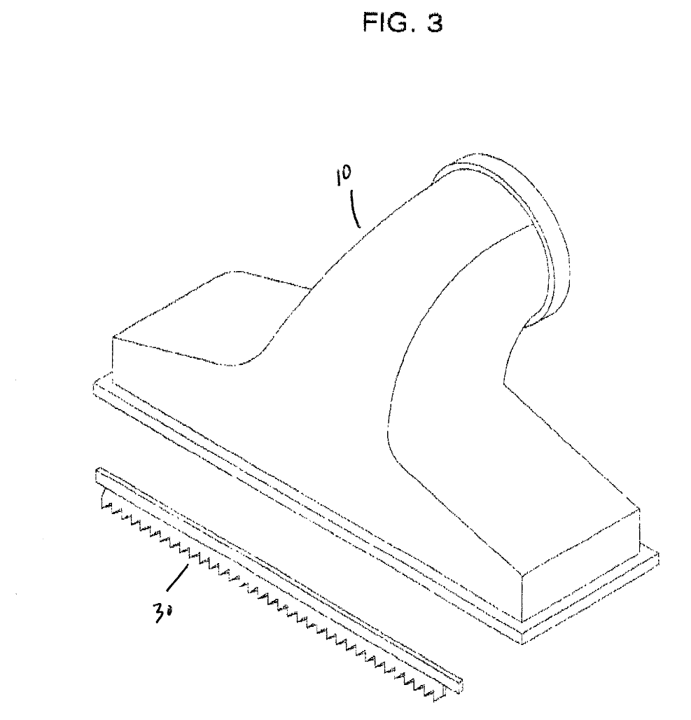

FIG. 4 illustrates an underside view of the utility nozzle and a perspective view of the hair comb member.

### DESCRIPTION OF THE PREFERRED EMBODIMENTS

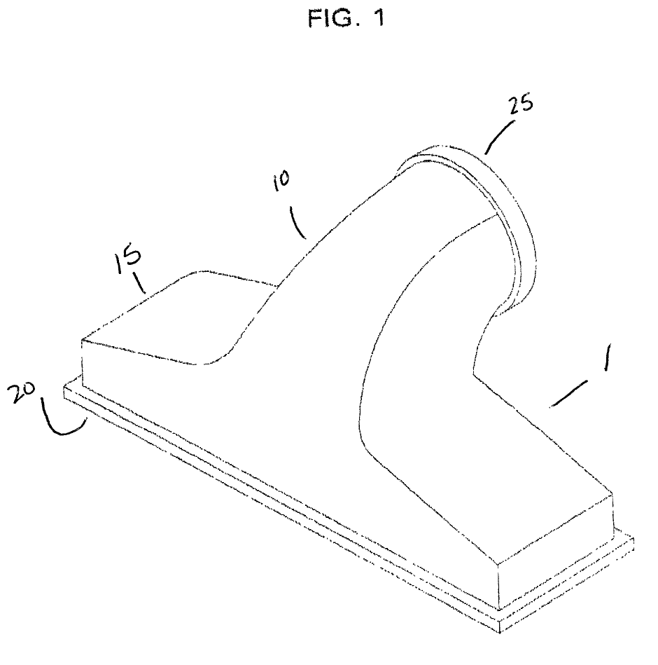

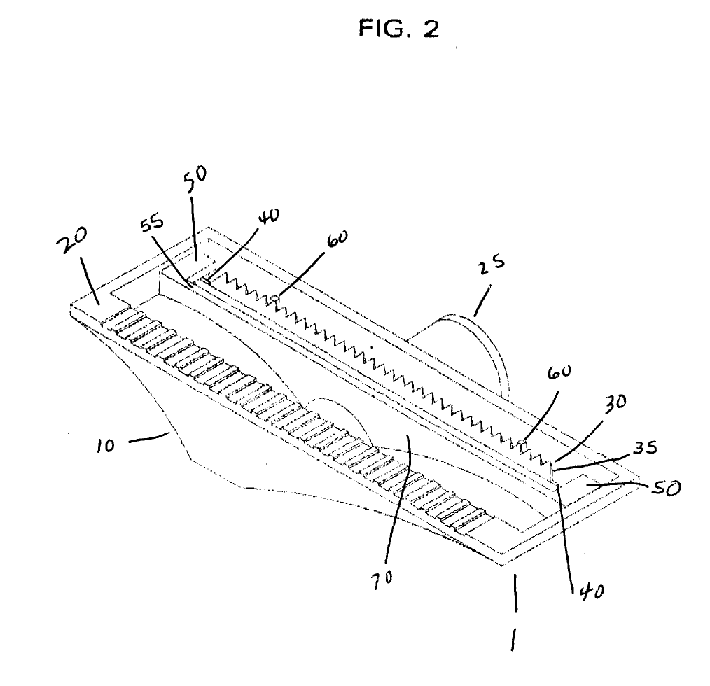

FIGS. 1 and 2 illustrate a preferred embodiment of a utility nozzle with comb member for grooming pets 1 made in accordance with the present invention, as best shown in the drawings, an apparatus 1 generally a utility nozzle 10 and a hair comb member 30.

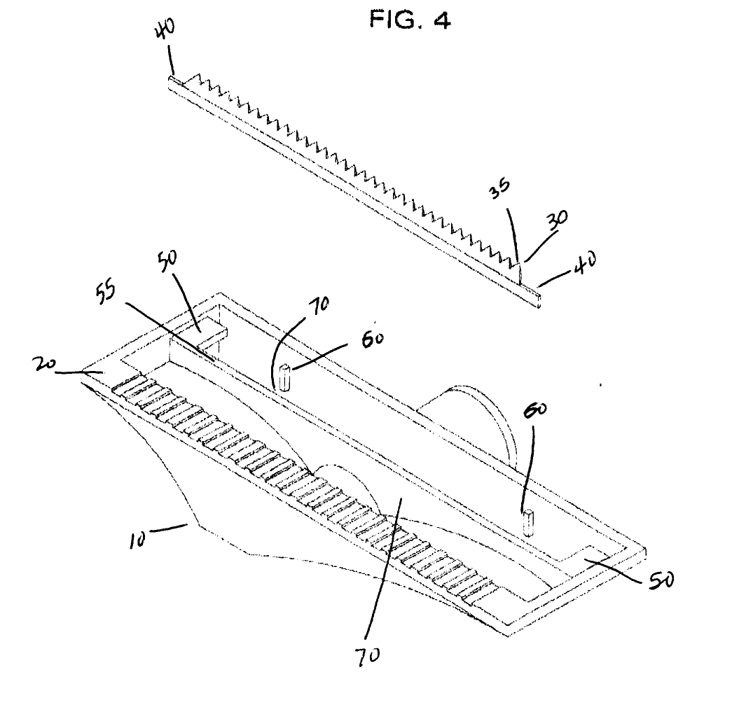

As shown in FIG. 1, a utility nozzle 10 further includes a topside 15, and a underside 20, and a connector 25 for connecting the nozzle 10 to a prior art vacuum (not shown). As best shown in FIG. 2 and FIG. 4, the utility nozzle 10 further includes an at least one tab 60, an air passage 70, a longitudinally extending center wall 55 that extends the approximate length of the underside 20 of the utility nozzle 10, and a first and second lip 50 disposed on opposite ends of the underside 20.

The hair comb member 30 including a plurality of cone-shaped teeth 35, and a first and second end 40 disposed on opposite ends of the hair comb member 30. The hair comb member 30 preferably extends along the entire length of the underside 20 of the utility nozzle 10.

As best illustrated in FIG. 2, the hair comb member 35 is slidably positioned within the underside 20 of the utility nozzle 10 between the at least one tab 60 and the center wall 50 of the utility nozzle 10. Further, the first and second ends 40 of the hair comb member 30 are slidably positioned immediately under and in contact with the first and second lips 50 of the utility nozzle 10. So when installed the plurality of cone-shaped teeth 35 of the hair comb member 30 extend upward in parallell relationship with the at least one tab 60 and on the same axis as the center wall 55 of the utility nozzle 10. And the preferred embodiment, said plurality of teeth 35 are all mounted in a single plane and of sturdy material in order to pass through the hair of a pet.

The hair comb member 30 may be easily removed from the utility nozzle 10 by slightly bending, either towards the center wall 55 or at least one tab 60, the hair comb member 30 within the utility nozzle 10 so that the ends 40 slip out from under the lip 50, and then simply sliding the hair comb member 30 in a direction away from the utility nozzle 10. Once removed, a replacement comb or another attachment to the nozzle 10, such as a prior art brush (not shown) may be inserted in the nozzle 10 similar to the insertion of the hair comb member 30.

When the apparatus 1 is attached to the vacuum, and the vacuum is activated, air passes through the air passage 70 of the utility nozzle 10 and converges into the vacuum. During use, the apparatus 1 and specifically the hair comb member 30 is pulled through the pet's hair and against the pet's skin while grooming. The nature of the material of the plurality of cone-shaped teeth 35 prevents the teeth 35 from causing discomfort to the animal, and in fact, in most cases, the animal will find the process enjoyable. Further, while the apparatus 1 is pulled through the pet's hair, the hair comb member 30 is capable of collecting hair and debris that is loosened from the pet when the plurality of cone-shaped teeth 35 engage the pet. Such collection of loosened hair and debris passes from the plurality of cone-shaped teeth 35 through the air passage 70 of the utility nozzle 10 into the vacuum. Should pet hair collect in the plurality of cone-shaped teeth 35, the user may simply loosen the hair from the plurality of cone-shaped teeth 35 thereby allowing such collection of hair and debris to pass through the passage 70 as discussed above.

During use, the apparatus is held in the user's hand and slowly and softly brushed over the animal's body. The pet hair that is matted on the animal's body will be dematted by the cone-shaped teeth 35 of the hair comb member 30 when combing. When grooming an animal's hair, the animal usually loses hair and other debris. This loose hair and debris will be vacuumed from the plurality of cone-shaped teeth 35 of the hair comb member 30 through the air passage 70 of the utility nozzle 10 into the vacuum. The apparatus is easily cleaned after grooming of the animal and very convenient to use. Finally, the apparatus aids in the prevention of loose hair and debris from falling on the floor and on furniture when the animal is being groomed.

The present invention provides a new and improved pet grooming apparatus which may be easily and efficiently manufactured and marketed. The present invention is susceptible of a low cost of manufacture with regard to both materials and labor, and which accordingly is then susceptible of low prices of sale to the consuming public, thereby making the present invention economically available to the buying public.

Although the description above contains many specificities, these should not be construed as limiting the scope of the invention but as merely providing illustrations of some of the presently preferred embodiments of this invention. For example, while the description and drawings describe the apparatus 1 as including the utility nozzle 10 and the hair comb member 30 removably attached to the utility nozzle 10, it should be understood that the utility nozzle 10 and the hair comb member 30 may be manufactured as a single unit.

Thus the scope of the invention should be determined by the appended claims in the formal application and their legal equivalence, rather than by the examples given.

I claim:

1. An apparatus for removing hair and debris from a pet when grooming the pet, said apparatus comprising:
a utility nozzle having an air passage; and
a hair comb member disposed contiguous the air passage.

2. The apparatus as recited in claim 1, wherein the hair comb member comprising a plurality of teeth, said teeth capable of collecting the hair and debris loosened from the pet when the plurality of teeth engage the pet, so that the collection of loosened hair and debris passes from the plurality of teeth through the air passage and into the vacuum.

3. An apparatus for grooming pets that attaches to a prior art vacuum, said apparatus comprising:
a utility nozzle; and
a hair comb member;
wherein said hair comb member having a plurality of teeth, to permit the collection of pet hair and debris when the plurality of teeth engage the pet.

4. The apparatus as recited in claim 3, wherein the utility nozzle comprising:
at least one tab;
an air passage;
a center wall; and
a first and second lip;
wherein the hair comb member is removably attached to the utility nozzle contiguous the air passage, between the at least one tab and the center wall, so that the collection of loosened hair and debris passes from the plurality of teeth through the air passage of the utility nozzle into the vacuum.

5. An apparatus for grooming pets that attaches to a prior art vacuum, said apparatus comprising:
a utility nozzle having at least one tab, an air passage, and a first and second lip disposed on opposite ends of the utility nozzle; and
a hair comb member having a plurality of upwardly extending cone-shaped teeth, and a first and second end disposed on opposite ends of the hair comb member;
wherein the hair comb member is attached to the utility nozzle between the at least one tab and the center wall of the utility nozzle.

6. The apparatus as recited in claim 5, wherein the first and second ends of the hair comb member are removably positioned immediately under and in contact with the first and second lips of the utility nozzle.
